(19) United States
(12) Patent Application Publication
(10) Pub. No.: US 2026/0134081 A1
(43) Pub. Date: May 14, 2026

(54) System and method using a cognitive password to connect to a computer system

(71) Applicant: Bank of America Corporation, Charlotte, NC (US)

(72) Inventors: Kalyan V. Pasumarthi, Frisco, TX (US); Usha Pasumarthi, Frisco, TX (US); Ramakrishna R. Yannam, The Colony, TX (US); Xianhong Zhang, Issaquah, WA (US); Rakesh Juyal, Bothell, WA (US)

(21) Appl. No.: 18/945,823

(22) Filed: Nov. 13, 2024

(51) Int. Cl. G06F 21/46; H04L 9/40

(52) U.S. Cl. CPC G06F 21/46; H04L 63/0846

(57) ABSTRACT

A system that includes a processor and a memory is provided to determine if an external device is allowed to access a computer resource. The memory stores a first password, a dynamic sequence that changes on a periodic schedule, and a plurality of patterns for altering the cognitive password. When a request to access the computer resource is received from the external device, one of the plurality of patterns is sent to it. The processor then receives an altered password, which is the cognitive password altered according to the sent pattern. Using an inverse of the pattern, the cognitive password is restored. The dynamic sequence is then removed from the cognitive password to recover a second password. The external device is then allowed to access the computer resource when the second password is identical to the first password.

### TECHNICAL FIELD

The present disclosure relates generally to networked computing and, more specifically, to a system and method using a cognitive password to connect to a computer system.

### BACKGROUND

Large organizations often utilize complex computing systems, such as data centers, to conduct day-to-day operations. Many applications and computing devices in these systems may be operating and host or provide sensitive information to connected external devices. These systems utilize various security measures to protect this sensitive information from unauthorized access and/or manipulation.

### SUMMARY

The system and method disclosed in the present application provide a technical solution to the technical problems discussed above by providing a cognitive password for accessing a computer resource. Bad actors frequently attempt to obtain passwords in order to access computer resources and perform malicious activities using malware, such as, but not limited to ransomware, viruses, and theft. These attacks lead to potential financial losses and can result in wasting computer processing and storage space for storing and executing malicious programs that the bad actors install. For example, many bad actors use compromised passwords to install malware on a server for ransomware attacks; even when unsuccessful, these attacks may use substantial amounts of data and resources for detection, elimination, and/or deployment.

While the careful use of increasingly complex passwords that are many characters in length may prevent some bad actors from accessing important computer resources, bad actors can overcome these passwords using brute force techniques and man-in-the-middle attacks. In a man-in-the-middle attack, a bad actor monitors the network traffic between an external device and the computation resource to extract the passwords and other useful data, as well as perform other malicious activities.

The system and method provide for better performance of computer resources in a complex computational system as computer resources are not being misappropriated by malware due to the use of a cognitive password. The cognitive password is a dynamic password that makes it more difficult for a malicious actor to gain unauthorized access to a computer resource while not requiring significant additional resources or actions to allow authorized access to the computer resources. This, along with other aspects of the system and method described below, will make passwords more secure and result in fewer successful attacks by bad actors.

The disclosed system and method determine if an external device is allowed to access a computer resource. The system and method store a first password, a dynamic sequence that changes on a periodic schedule, and a plurality of patterns for altering the cognitive password. When a request to access the computer resource is received from the external device, one of the plurality of patterns is sent to the external device. The system and method then receive back an altered password, which is the cognitive password altered in accordance with the sent pattern. Using an inverse of the pattern, the cognitive password is restored. The dynamic sequence is then removed from the cognitive password to recover a second password. The external device is then allowed to access the computer resource when the second password is identical to the first password.

The system and method disclosed in the present application include a processor operably coupled to a memory configured to store a first password, a dynamic sequence of characters, and a plurality of patterns. The first password is a static sequence of characters required to access a computer resource. The dynamic sequence comprises a dynamic sequence of characters that change on a periodic schedule, and the dynamic sequence of characters and the periodic schedule is based on a previously selected type of sequence to be used with the first password. The plurality of patterns are computer instructions for altering the contents of a cognitive password.

The processor is configured to receive a request to access the computer resource from an external device. It then identifies one of the plurality of patterns and sends the selected one to the external device. Once the identified pattern is sent to the external device, an altered password is received from the external device. The altered password is the cognitive password that has been altered in accordance with the identified one of the plurality of patterns.

The processor changes this altered password into the cognitive password by using an inverse of the identified one of the plurality of patterns. The processor then removes the dynamic sequence from the cognitive password to recover a second password and compares the second password to the stored first password. The processor then allows the external device to access the computer resource when the second password is identical to the first password.

The disclosed system and method provide several practical applications, such as providing an efficient manner for producing and using a more secure password to access computer resources. The disclosed system and method at least make it more difficult for a bad actor to determine a password to attack a server or other computer system hosting a resource. This prevents potential damage to a user's account and may additionally result in the server hosting a desired computer resource and not needing to use as many computing resources to defend against attacks or successful service attacks.

Certain embodiments of the present disclosure may include some, all, or none of these advantages. These advantages and other features will be more clearly understood from the following drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system configured for using a cognitive password to gain access to a computer resource; and

FIG. 2 illustrates one embodiment of a flowchart for using a cognitive password to gain access to a computer resource.

### DETAILED DESCRIPTION

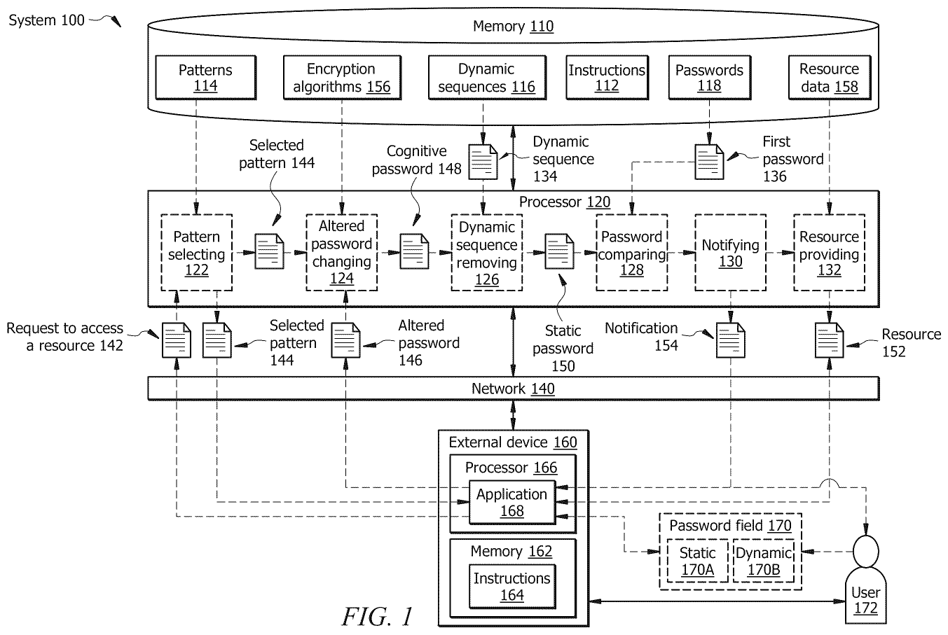

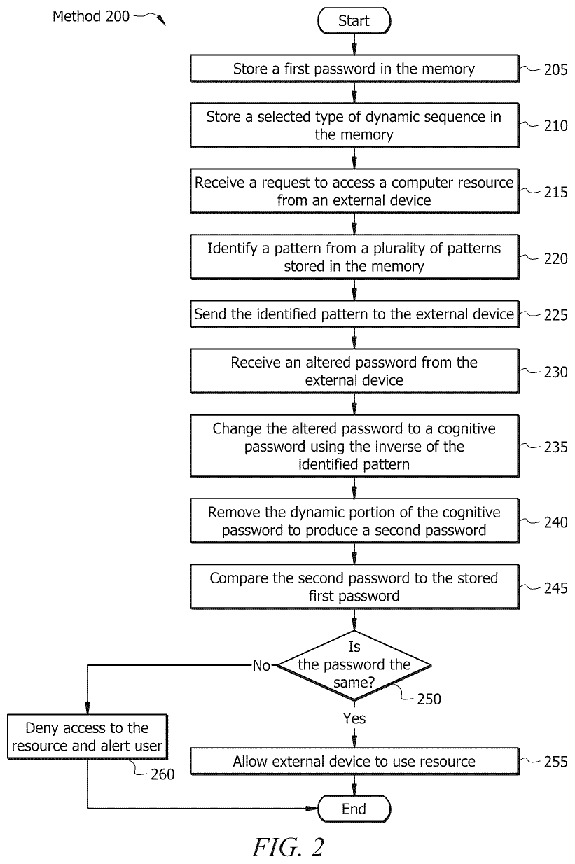

As described above, conventional solutions for providing secure access to a computer resource using a password are insufficient to prevent bad actors from gaining access to the computer resource. Even when unsuccessful, these attacks may use substantial amounts of data, network resources, and other resources for detection, elimination, and/or deployment. Current methods of providing a more secure password require a token or other device or applications that can be compromised. Alternatively, a user has to remember a sequence of passwords or, more likely, write them down, which is easily compromised. The one or more embodiments of this disclosure provide a system and method that utilizes a dynamic password that includes a cognitive password, which makes it more difficult for a bad actor to gain access to a computer resource by intercepting a password or obtaining it by other means while using less computational power and causing less network latency than conventional solutions. Embodiments of the disclosure and its advantages may be understood by referring to FIG. 1 and FIG. 2.

### System, Overview

FIG. 1 is a schematic diagram of a system 100 configured for allowing an external device 160 to access a resource 152. More specifically, system 100 utilizes an altered password 146 that more securely allows the external device 160 to access the resource 152. The altered password 146 includes a cognitive password 148 that has been changed based on an identified pattern 144 that is communicated to the external device 160 prior to the altered password 146 being sent from the external device to the processor 120. The cognitive password 148 includes a static password 150 and a dynamic sequence 134. The static password 150 is compared with a saved password to determine whether access to a resource 152 is permitted or to send a notification 154 to a user 172 that an unauthorized attempt was made to access the resource 152.

In one embodiment, system 100 comprises an external device 160, a network 140, a processor 120, and a memory 110. The processor 120 and memory 110 are in signal communication through the network 140 with the external device 160. The system 100 may be configured as shown or in any other suitable configuration.

### System Components

### External Device

The external device 160 may include any number of devices that perform one or more applications 168. Examples of an external device 160 may include but are not limited to, computers, laptops, mobile devices (e.g., smartphones or tablets), servers, clients, automated teller machines (ATM), point of sale devices (POS), or any other suitable type of devices that may be used for accessing or supporting an application 168. In one or more embodiments, the external device 160 may be a user device for use by a user 172. The external device 160 may include a user interface, such as a display, a microphone, a keypad, or other appropriate terminal equipment usable by the user 172.

The external device 160 may include a processor 166, memory 162, and/or circuitry (not explicitly shown) configured to perform any of the functions or actions of the external device 160, including application 168 described herein. While only one external device 160 is shown, in one or more embodiments, a plurality of external devices, e.g., 160, may be present, each hosting an application 168 or a plurality of applications, e.g., 168. In one or more embodiments, the application 168 hosted by the external device 160 may be a decentralized application 168 and/or may take any other form and may be hosted by more than one external device, e.g., 160.

The external device 160 may include a memory 162 for storing instructions 164 for performing one or more applications 168. The memory 162 may also include any data needed for executing the application 168 or any other actions or operations associated with the external device 160. The memory 162 may be any type of storage for storing instructions 164 that are executed by the processor 166. The memory 162 may be a non-transitory computer-readable medium in operative communication with the processor 166. The memory 162 may be one or more disks, tape drives, or solid-state drives. Alternatively, or in addition, the memory 162 may be one or more cloud storage devices. The memory 162 may be volatile or non-volatile. It may comprise read-only memory (ROM), random-access memory (RAM), ternary content-addressable memory (TCAM), dynamic random-access memory (DRAM), and static random-access memory (SRAM).

The external device 160 includes at least one processor 166 operatively connected to the memory 162. The at least one processor 166 performs one or more processes or operations, including performing the application 168. Application 168 may require, among other things, access to a resource 152, which may be associated with the processor 120 or with another external device, e.g., 160. The processor 166 executes instructions 164 stored in the memory 162 to perform the application 168. The application 168 may include such applications as web browsing, banking applications, word processing applications, entertainment applications, video applications, and/or any other applications that the external device 160 may host. Some of these applications 168 may be user applications that a user 172 interacts with.

When executing the application 168, the processor 166 may perform various operations or actions. The processor 166 may make API calls, perform batch jobs, modify application data (not shown) stored in memory 162, and modify application data stored in other external devices (not shown). The processor 166 may also perform one or more mathematical and logical operations, start and/or maintain active threads, and send and/or receive data or other information through and from the network 140. The processor 166 may perform other operations not listed above without departing from the disclosure; those listed are provided only as examples. For example, software applications 168 designed using software code may be stored in the memory 162 as instructions 164 and executed by the processor 166 to perform the functions of the external device 160. The external device 160 is configured to communicate with other components of the system 100 via the network 140.

The user 172 or another party using the external device 160 may possess user credentials used by the processor 166 performing instructions 164 to authenticate the user 172, application 168, and/or external device 160 to allow access to one or more resources 152. The user credentials may include a first or static password 150 and a dynamic sequence 134, which is used to produce a dynamic sequence 116. The static password 150 and the dynamic sequence 116 may comprise a multi-digit alphanumeric string. In one or more embodiments, the static password 150 may comprise an eight-digit or eight-character alphanumeric string. However, the static password 150 may be of any size and any combination of characters as required by the security policies of the organization providing resource 152 and/or a user's 172 preferences.

In operation, the external device 160 performing application 168 sends a request to access a resource 142. In response, the external device 160 receives an identified pattern 144. As a result, the application 168 causes the external device 160 to display a password field 170. The password field 170 may comprise a static field 170A and a dynamic field 170B. Alternatively, the password field 170 may be a single field where the combined cognitive password 148 is entered by the user 172. The static field 170A is configured to receive the static password 150 from the user 172, and the dynamic field 170B is configured to receive a dynamic sequence 116 from the user 172. The static field 170A and the dynamic field 170B may each be a multi-digit or a multi-character field and may be arranged in any desired configuration.

In one or more embodiments, the dynamic sequence 134 entered into the dynamic field 170B is a pre-selected sequence of characters that change on a periodic schedule based on a previously selected type of sequence. In general, the dynamic sequences 134 of any type of periodical change on a predetermined and predictable schedule, resulting in a dynamic password that both the processor 120 and the external device 160 and/or user 172 may easily and accurately reproduce. The dynamic sequence 134 in one or more embodiments may be chosen by the user 172 or application 168 when the first password 136 is established with the processor 120. Alternatively, the dynamic sequence 134 may be chosen by the processor 120 from a plurality of possible dynamic sequences 116 and communicated to the external device 160 or user 172 prior to the user requesting access to a resource 142 or sending the altered password 146 to the processor 120.

The user 172, or alternatively, the application 168, enters the static password 150 into the static field 170A and the dynamic sequence 134 into the dynamic field 170B. In response, the external device 160 produces the cognitive password 148. The processor 166 or application 168 then applies the identified pattern 144 to the cognitive password 148 to make the altered password 146. The identified pattern 144 is one of a plurality of patterns 114 stored in memory 110 that comprises computer instructions for altering the contents of a cognitive password 148.

The plurality of patterns 114 may take any form that is reversable by applying the inverse of the pattern to the altered password 146 to recover the original cognitive password 148. For example, in a non-limiting example, the identified pattern 144 may shuffle the characters of the cognitive password 148, for example, in a non-limiting example, placing the fifth and sixth characters at the front of the password. Another example is changing letters in the cognitive password 148 to corresponding numerical values and performing a mathematical operation to change that value. The identified pattern 144 may be any type of operation for altering the contents of the cognitive password 148 to produce an altered password 146, and the disclosure is not limited to those described herein.

In one or more embodiments of the disclosure, the resulting altered password 146 is optionally further subjected to encryption. This may take the form of a symmetric key, public key, or any other form of encryption. It may also be standard encryption associated with a web browser, such as transport layer security (TLS) or secure sockets layer (SSL). However, the encryption may take any form, and the disclosure is not limited to the types of encryption described above.

Once the altered password 146 (with or without encryption) is produced, the processor 166 sends the altered password 146 to the processor 120. The external device 160 is further configured to receive a notification 154 indicating whether or not authentication was successful. When the notification 154 indicates that authentication of the user 172 and/or external device 160 is successful, the external device 160 gains access to the resource 152. However, if the cognitive password 148 includes a static password 150 that does not match the password 118 stored in the memory 110 or the dynamic sequence 134 is incorrect, the notification 154 may indicate that access to the resource 152 is denied. Additionally, or alternatively, the notification 154 may be sent to user 172 by a different means than the external device 160 to alert the user 172 and/or the administrator that an unsuccessful attempt to access resource 152 has been made.

While FIG. 1 shows the external device 160, including only a single processor 166 and a memory 162, they may include any suitable number and combination of processors, e.g., 166 and memories 162, as well as any other necessary components. For simplicity, only one processor, e.g., 166, and one memory, e.g., 162, are shown in FIG. 1.

### Network

The network 140 may be any suitable type of wireless and/or wired network including, but not limited to, all or a portion of the Internet, an intranet, a private network, a public network, a peer-to-peer network, the public switched telephone network, a cellular network, a local area network (LAN), a metropolitan area network (MAN), a wide area network (WAN), and a satellite network. The network 140 may be configured to support any suitable type of communication protocol as would be appreciated by one of ordinary skill in the art.

The network 140 may connect the external device 160 with the processor 120 and memory 110. Alternatively, network 140 may connect the external device 160 through the Internet or other large networks. In one or more embodiments, different elements of system 100 may be at different geographic locations and connected through network 140. While shown as a single network 140, the network 140 may comprise a plurality of components of any suitable networking equipment, including but not limited to routers and switches, that allow at least the external device 160 to communicate with the processor 120 and/or memory 110. Network 140 is not limited to the configuration shown in FIG. 1, which is simply shown in this form for simplicity and explanatory purposes.

### Memory

Memory 110 may be any type of storage for storing a computer program comprising instructions 112, patterns 114, dynamic sequences 116, passwords 118, and resource data 158. The memory 110 may be a non-transitory computer-readable medium in operative communication with the processor 120. The memory 110 may be one or more disks, tape drives, or solid-state drives. Alternatively, or in addition, the memory 110 may be one or more cloud storage devices. The memory 110 may be volatile or non-volatile. It may comprise read-only memory (ROM), random-access memory (RAM), ternary content-addressable memory (TCAM), dynamic random-access memory (DRAM), and static random-access memory (SRAM).

The memory 110 stores instructions 112, which, when executed by the processor 120, causes the processor 120 to perform the operations shown in FIG. 2 and described below. Instructions 112 may comprise any suitable set of instructions, logic, rules, or code. Memory 110 may include storage that may take the form of a database for storing things such as patterns 114, dynamic sequences 116, passwords 118, and resource data 158. These may be stored and recalled using known protocols such as SQL, XML, and/or any other protocol or language that a user 172, administrator, or developer of the system 100 wishes to use. The instructions 112, patterns 114, dynamic sequences 116, passwords 118, resource data 158, and any other information stored in memory 110 may be stored in different forms. The disclosure is not limited to storing the instructions 112, patterns 114, dynamic sequences 116, passwords 118, and resource data 158 as a database.

In one or more embodiments, the memory 110 stores a plurality of patterns 114. The plurality of patterns 114 may take any form that is reversable by applying the inverse of the pattern to the altered password 146 to recover the original cognitive password 148. For example, in a non-limiting example, the identified pattern 144 may shuffle the characters of the cognitive password 148, for example, in a non-limiting example, placing the fifth and sixth characters at the front of the password. Another example is changing letters in the cognitive password 148 to corresponding numerical values and performing a mathematical operation to change that value. The identified pattern 144 may be any type of operation for altering the contents of the cognitive password 148 to produce an altered password 146, and the disclosure is not limited to those described herein.

In one or more embodiments, the memory 110 stores a plurality of dynamic sequences 116. In one or more embodiments, the dynamic sequences 116 are a sequence of characters that change on a periodic schedule based on a previously selected type of sequence. In general, the periodic schedule may be any type of periodical change that occurs on a predetermined and predictable schedule. By using the predetermined and predictable schedule to produce the sequence of characters for the dynamic sequences 116, a dynamic password is produced that both the processor 120 and the external device 160 and/or user 172 may easily and accurately reproduce. For example, the sequence of characters may be a type related to the current date, time, day of the week, Roman month, or other type of periodically changing phenomenon that a user 172 would be able to easily remember or determine without the addition of additional computations by the processor 166 of the external device 160 or another external device, e.g., 160. For example, if a selected type of dynamic sequence is a date of the week, then the dynamic sequence may be “Monday” or “02” (for the second day of the week). Similarly, if it is a calendar date, it may be 102524 or Oct2524 or any other agreed-upon sequence. The type of sequences may be specific for a particular location; for example, if the type is a calendar date in some locations, it may be 251024 or based on a non-Gregorian calendar.

In one or more embodiments, the memory 110 stores one or more passwords 118. The one or more passwords 118 may include a first password, e.g., 136, that allows access to a resource 152. The one or more passwords 118, which may include a first password 136, are a static sequence of characters that are similar or identical to a static password 150 provided by the user 172 to access a resource 152. In one or more embodiments, the one or more passwords 118 as well as the static password 150 may comprise an eight-digit or eight-character alphanumeric string. However, the one or more passwords 118 and static password 150 may be of any size and any combination of characters as required by the security policies of the organization providing resource 152 and/or a user's 172 preferences. The one or more passwords 118 may take the form of a user's 172 traditional password, for example, “Password123”. The one or more password 118 and the static password 150 may be any combination of characters as required by an organization's security policy. In another example, the one or more passwords 118 may take the form of “P@ssword123”, where the security policy requires a non-alphanumeric character; alternatively, the one or more passwords 118 may take the form of a sequence of numbers or a PIN code such as “12345”. Memory 110 may store a plurality of static passwords 118 associated with different users, e.g., 172, external device, e.g., 160, and a user 172 may be associated with more than one, where different passwords 118 are used for accessing different resources 152 or performing different activities.

In one or more embodiments, the memory 110 may also store encryption algorithms 156. These encryption algorithms 156 may take the form of algorithms for performing symmetric key encryption, public key encryption, or any other form of encryption. They may also be algorithms for performing standard encryption associated with a web browser, such as transport layer security (TLS) or secure sockets layer (SSL). The encryption algorithms 156 may take any form, and the disclosure is not limited to the types of encryption described above.

In one or more embodiments, the memory 110 may also store resource data 158. Resource data 158 may be the actual resource 152 or data needed for the processor 120 to perform an activity associated with resource 152. Alternatively, or additionally, the resource data 158 may be located on an external device, e.g., 160, that may be accessed by the processor 120 or the external device 160 when access to the computer resource 152 is granted by the processor 120. The resource data 158 may be in the form of a database or may take any other form. The resource data 158 may be account data, video data, image data, personal data, or another type of data needed for performing or providing resource 152.

### Processor

The processor 120 may take the form of any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 120 may be a programmable logic device, a microcontroller, a microprocessor, or any suitable combination of the preceding. The processor 120 is communicatively coupled to and in signal communication with the memory 110. The one or more processors making up the processor 120 are configured to process data and may be implemented in hardware or software. For example, the processor 120 may be 8-bit, 16-bit, 32-bit, 64-bit, or of any other suitable architecture. The processor 120 may include an arithmetic logic unit (ALU) for performing arithmetic and logic operations; processor registers that supply operands to the ALU and store the results of ALU operations, and a control unit that fetches instructions 112 from memory 110 and executes them by directing the coordinated operations of the ALU, registers and other components. The processor 120 may be a special-purpose computer designed to implement the instructions 112 and/or functions disclosed herein. For example, the processor 120 may be configured to perform operations, including those described below and shown in FIG. 2.

The processor 120 may perform pattern selecting 122, altered password changing 124, dynamic sequence removing 126, password comparing 128, notifying 130, and resource providing 132 based on the instructions 112 stored in the memory 110. The processor 120 may perform more or less operations than shown in FIG. 1 and FIG. 2; the specific operations shown are only examples. While a single processor 120 is shown, the processor 120 may include a plurality of processors or computational devices. The operations, e.g., pattern selecting 122, altered password changing 124, dynamic sequence removing 126, password comparing 128, notifying 130, and resource providing 132, described herein as being performed by the processor 120 may be performed by a separate processor, e.g., 120 or software application executed on a single computational device, e.g., processor 120, or they may be located on separate servers, separate datacenters such as a cloud server and/or one or more of external devices, e.g., 160.

In one or more embodiments, the processor receives a request to access a resource 142 from the external device 160. This request to access a resource 142 is sent from the external device 160 through the network 140. The request to access a resource 142 indicates which resource 152 that the external device 160 performing application 168 needs access to. In one or more embodiments, the request to access a resource 142 is a request to change either the dynamic sequence 134 and/or the first/static password 118. This may occur when the first password 136 is initially established or at the request of the user 172 after receiving a notification 154 that their static password 118 and/or dynamic sequence 134 may have been compromised. The request to access a resource 142 is not limited to requesting a change in the dynamic sequence 134 and/or the static password 118. It may be for any other type of resource 152, including accessing a user's 172 profile, user's data 172, or any other resource 152 that typically requires the entry of a static password 150.

This may be, for example, in a non-limiting example, an indication that the application 168 needs access to a web page when the application 168 is a web browser. In another example, it may be an indication that the application 168 needs resource data 158 stored in the memory 110, such as an account balance. In yet another example, it may be a request to access a resource 142, such as streaming video. In general, the request to access a resource 152 may take any form and be for any resource 152, and the disclosure is not limited to the above examples.

Once the processor 120 receives the request to access a resource 142, the processor 120 performs pattern selecting 122. The processor receives from the memory 110 one or more patterns 114. The processor 120, when performing pattern selecting 122, may randomly select one of the plurality of patterns 114. Alternatively, the processor 120 may use one or more schedules to identify and select an identified pattern 144. In one or more embodiments, each time the external device 160 sends a request to access a resource 142, a new pattern is selected to be sent as the identified pattern 144. This is to keep a potential bad actor from being able to learn or guess the patterns 114.

As described above, these patterns 114 are computer instructions or algorithms that may take any form that is reversible by applying the inverse of the pattern to the altered password 146 to recover the original cognitive password 148. For example, in a non-limiting example, the identified pattern 144 may shuffle the characters of the cognitive password 148, for example, in a non-limiting example, placing the fifth and sixth characters at the front of the password. Another example is changing letters in the cognitive password 148 to corresponding numerical values and performing a mathematical operation to change that value. The identified pattern 144 may be any type of operation for altering the contents of the cognitive password 148 to produce an altered password 146, and the disclosure is not limited to those described herein.

Once the processor 120 performs pattern selection 122, it sends the identified pattern 144 to the external device 160. The processor then receives an altered password 146 from the external device 160. The altered password 146 is the cognitive password 148 that has been altered in accordance with the identified pattern 144 that was identified from the plurality of patterns 114. In one or more embodiments, the altered password 146 may also have been encrypted by the external device 160 or one or more components of the network 140, using one or more encryption algorithms 156.

The processor 120 receives the altered password 146 and performs altered password changing 124. If the altered password 146 has been encrypted using an encryption algorithm 156, the processor 120, performing altered password change 124, decrypts the altered password 146. Alternatively, or additionally, the processor 120 uses the inverse of the identified pattern 144 to recover the cognitive password 148. For example, in a non-limiting example, if the identified pattern 144 was to place the first two numbers in the cognitive password 148 first, then the inverse would return the first two numbers to their original position (e.g., cognitive password 148 “P@ssword123” becomes 12P@ssword3 as an altered password 146, when the processor 120 performs altered password changing 124, the “12” is moved back to restore the cognitive password 148 “P@ssword123”.

Once the cognitive password 148 is recovered by the processor 120, it performs dynamic sequence removing 126. The processor retrieves from the memory 110 the current dynamic sequence 134 and removes it from the cognitive password 148, recovering the static or second password 150. The dynamic sequence 134 in one or more embodiments may be chosen by the user 172 or application 168 when the first password 136 is first established with the processor 120. Alternatively, the dynamic sequence 134 may be chosen by the processor 120 from a plurality of possible dynamic sequences 116 and communicated to the external device 160 or user 172 prior to the user requesting access to a resource 142 or sending the altered password 146 to the processor 120. In one or more embodiments, if the dynamic sequence used by the external device 160 to make the cognitive password 148 does not match the dynamic sequence 134 stored in memory, then the processor performs notifying 130 and sends a notification 154 to the external device 160 and/or user 172 that access was denied.

In one or more embodiments, once the processor 120 performs dynamic sequence removing 126, the processor 120 performs password comparing 128 on the static or second password 150. The processor 120 retrieves the first or stored static password 118 from the memory 110 and compares it to the recovered static second password 150. If the first password 136 and second password 150 match, the processor 120 allows access to the resource 152. The processor 120 sends a notification 154 to the external device 160 and/or user 172, indicating that access is granted to the resource 152, and the processor 120 begins performing resource providing 132. Resource providing 132 provides the resource 152 to the external device 160.

In one or more embodiments, if the second static password 150 does not match the first or stored static password 118 retrieved from the memory 110, the processor 120 performs notifying 130. It sends a notification 154, which may take the form of an alert or alarm to the user 172 and/or the external device 160. The notification 154 may go to user 172 and may also be sent to system administrators (not shown), security professionals (not shown), and other concerned parties. This will allow appropriate action to be taken to mitigate or prevent unauthorized access to the resource 152 as well as reduce the amount of computer and network resources needed to process attacks such as malware. The notifying 130 in one or more embodiments may include the processor 120 performing other security actions, and the disclosure is not limited to preventing access to the resource 152 and notifying 130 the user 172 and/or external device 160.

### Process for Monitoring and Adjusting Energy Use by an External Device

FIG. 2 is a flowchart of an embodiment of method 200 performed by a processor 120 for using a cognitive password 148 received from an external device 160 to gain access to a computer resource 152. The processor 120 may execute instructions 112 stored in the memory 110, which employ method 200 for receiving an altered password 146 containing a cognitive password 148 from an external device 160 and/or user 172 and determine if the external device 160 has permission to access a computer resource 152 based on the verification of the cognitive password 148.

Method 200 begins at operation 205 when processor 120 stores a first password 136 in the memory 110. The first password 136 is a static sequence of characters that are either generated by the processor 120 or provided by the user 172 to access a resource 152. The first password 136, is usually stored when either an account or profile is initially set up or whenever the user 172 decides to change their password 136. The first password 136, may take the form of a user's 172 traditional password, for example, “Password123”.

In one or more embodiments, the first password 136 may comprise an eight-digit or eight-character alphanumeric string. However, the first password 136 may be of any size and any combination of characters as required by the security policies of the organization providing resource 152 and/or a user's 172 preferences. The first password 136, may be any combination of characters as required by an organization's security policy. In another example, the first password 136 may take the form of “P@ssword123”, where the security policy requires a non-alphanumeric character; alternatively, the first password 136 may take the form of a sequence of numbers or a PIN code such as “12345”.

At the same time or after the processor 120 stores the first password 136 in the memory 110 in operation 205, the processor 120 in operation 210 stores a selected dynamic sequence 134 in the memory 110. The user 172 or the external device 160 may select a particular type of dynamic sequence 134. In one or more embodiments, the dynamic sequences 116 are a sequence of characters that change on a periodic schedule based on a previously selected type of sequence. In general, the periodic schedule may be any type of periodical change that occurs on a predetermined and predictable schedule. By using the predetermined and predictable schedule to produce the sequence of characters for the dynamic sequences 134. For example, the sequence of characters may be a type related to the current date, time, day of the week, Roman month, or other type of periodically changing phenomenon that a user 172 would be able to easily remember or determine without the addition of additional computations by the processor 166 of the external device 160 or another external device, e.g., 160. For example, if a selected type of dynamic sequence 134 is a date of the week, then the dynamic sequence 134 may be “Monday” or “02” (for the second day of the week). Similarly, if the dynamic sequence 134 type is a calendar date, type dynamic sequence 134 may be 102524, Oct2524, 10252024, Oct252024, or any other agreed-upon sequence. For example, this sequence on the following day would change to 102624. The type of sequences may be specific for a particular location; for example, if the type is a calendar date in some locations, it may be 251024 or based on a non-Gregorian calendar.

At some time later, after the processor 120 stores a first password in operation 205 and stores a selected dynamic sequence 134 in operation 210, the processor 120 receives a request to access a computer resource 142 from an external device 160 in operation 215. This request to access a resource 142 is sent from the external device 160 through the network 140. The request to access a resource 142 indicates which resource 152 that the external device 160 performing application 168 needs access to.

In one or more embodiments, the request to access a resource 142 is a request to change either the dynamic sequence 134 and/or the first/static password 118. This may occur when the first password 136 is initially established or at the request of the user 172 after receiving a notification 154 that their static password 118 and/or dynamic sequence 134 may have been compromised. The request to access a resource 142 is not limited to requesting a change in the dynamic sequence 134 and/or the static password 118. It may be for any other type of resource 152, including accessing a user's 172 profile, user's data 172, or any other resource 152 that typically requires the entry of a static password 150. In another non-limiting example, the request to access a resource 142 may be an indication that the application 168 needs access to a web page when the application 168 is a web browser. In yet another example, it may be an indication that the application 168 needs resource data 158 stored in the memory 110, such as an account balance. In yet another example, it may be a request to access a resource 142, such as streaming video. In general, the request to access a resource 152 may take any form and be for any resource 152, and the disclosure is not limited to the above examples.

Once the request to access a resource 142 is received by the processor 120, the processor 120 in operation 220 identifies a pattern 144 from a plurality of patterns 114 stored in the memory 110. The identified pattern 144 is a computer instruction or algorithm that may take any form that is reversible by applying the inverse of the pattern to an altered password 146 to recover the original cognitive password 148. For example, in a non-limiting example, the identified pattern 144 may shuffle the characters of the cognitive password 148, for example, in a non-limiting example, placing the fifth and sixth characters at the front of the password. Another example is changing letters in the cognitive password 148 to corresponding numerical values and performing a mathematical operation to change that value. The identified pattern 144 may be any type of operation for altering the contents of the cognitive password 148 to produce an altered password 146, and the disclosure is not limited to those described herein.

Once the processor 120 identifies a pattern 144 from a plurality of patterns 114 in operation 220, the processor 120 sends the identified pattern 144 to the external device 160 in operation 225. In response to sending the identified pattern 144 to the external device 160, the processor 120 in operation 230 receives an altered password 146 from the external device 160. The altered password 146 is the cognitive password 148 that has been altered in accordance with the identified pattern 144 that was identified from the plurality of patterns 114. In one or more embodiments, the altered password 146 may also have been encrypted by the external device 160 or one or more components of the network 140, using one or more encryption algorithms 156.

The processor 120 changes the altered password 146 to a cognitive password 148 using the inverse of the identified pattern 144 in operation 235. The processor 120 uses the inverse of the identified pattern 144 to recover the cognitive password 148. If the altered password 146 has been encrypted using an encryption algorithm 156, the processor 120 decrypts the altered password 146. For example, in a non-limiting example, if the identified pattern 144 was to place the first two numbers in the cognitive password 148 first, then the inverse would return the first two numbers to their original position (e.g., cognitive password 148 “P@ssword123” becomes 12P@ssword3 as an altered password 146, when the processor 120 performs altered password changing 124, the “12” is moved back to restore the cognitive password 148 “P@ssword123”.

Once the cognitive password 148 is recovered by the processor 120 in operation 235, the processor 120 in operation 240 removes the dynamic portion of the cognitive password 148 to produce a second password, e.g., static password 150. In operation 240, the processor 120 retrieves from the memory 110 the current dynamic sequence 134 and removes it from the cognitive password 148, recovering the second password 150. In one or more embodiments, if the dynamic sequence used by the external device 160 to make the cognitive password 148 does not match the dynamic sequence 134 stored in memory, then the processor performs notifying 130 and sends a notification 154 to the external device 160 and/or user 172 that access was denied.

In operation 245, the processor 120 compares the second password 150 to the stored or first password 136. The processor 120 also retrieves the first password 136 from memory 110 and compares it to the recovered second password 150. Finally, in operation 250, the processor 120 determines if the passwords, e.g., 150 and 136, are the same.

If the first password 136 and second password 150 match, the processor 120, in operation 255, allows access to resource 152. The processor 120 sends a notification 154 to the external device 160 and/or user 172, indicating that access is granted to resource 152, and the processor 120 begins performing resource providing 132. Resource providing 132 provides the resource 152 to the external device 160.

Alternatively, if the first password 136 and second password 150 do not, in operation 260, the processor 120 denies access to the resource 152 and sends a notification 154 that may take the form of an alert to at least the user 172. The notification 154 may take the form of an alert or alarm for the user 172 and/or the external device 160. The notification 154 may go to user 172 and may also be sent to system administrators (not shown), security professionals (not shown), and other concerned parties. This will allow appropriate action to be taken to mitigate or prevent unauthorized access to the resource 152 as well as reduce the amount of computer and network resources needed to process attacks such as malware. Once either operation 255 or 260 is completed, method 200 of FIG. 2 ends.

The present examples are to be considered illustrative and not restrictive, and the intention is not to be limited to the details given herein. For example, the various elements or components may be combined or integrated into another system, or certain features may be omitted or not implemented.

While several embodiments have been provided in the present disclosure, it should be understood that the disclosed systems and methods might be embodied in many other specific forms without departing from the spirit or scope of the present disclosure. The present examples are to be considered illustrative and not restrictive, and the intention is not to be limited to the details given herein. For example, the various elements or components may be combined or integrated into another system, or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To aid the Patent Office and any readers of any patent issued on this application in interpreting the claims appended hereto, applicants note that they do not intend any of the appended claims to invoke 35 U.S.C. § 140(f) as it exists on the date of filing hereof unless the words “means for” or “operation for” are explicitly used in the particular claim.

1. A system, comprising:
a memory configured to:
store a first password, wherein the first password is a static sequence of characters required to access a computer resource;
store a dynamic sequence, wherein the dynamic sequence comprises a dynamic sequence of characters that change on a periodic schedule; and
store a plurality of patterns, wherein the plurality of patterns are computer instructions for altering contents of a cognitive password; and
a processor operably coupled to the memory and configured to:
receive a request to access the computer resource from an external device;
identify one of the plurality of patterns and send the identified one of the plurality of patterns to the external device;
receive from the external device an altered password, wherein the altered password is the cognitive password that has been altered in accordance with the identified one of the plurality of patterns;
change the altered password to the cognitive password by using an inverse of the identified one of the plurality of patterns;
remove the dynamic sequence from the cognitive password to recover a second password;
compare the second password to the stored first password; and
allow the external device to access the computer resource when the second password is identical to the first password.

2. The system of claim 1, wherein the plurality of patterns comprises instructions to move a portion of a sequence of characters forming the cognitive password to a different location in the sequence of characters forming the cognitive password.

3. The system of claim 1, wherein the processor is further configured to:
determine the sequence of characters and periodic schedule associated with the stored dynamic sequence from a selected type of dynamic sequence; and
receive an indication of the selected type of dynamic sequence from the external device prior to storing the dynamic sequence.

4. The system of claim 1, wherein the processor is further configured to:
select a type of dynamic sequence from a plurality of types of dynamic sequences;
communicate the type of dynamic sequence to the external device prior to receiving from the external device the altered password; and
determine the sequence of characters and periodic schedule associated with the stored dynamic sequence from the selected type of dynamic sequence.

5. The system of claim 1, wherein the dynamic sequence of characters is based at least on a current date.

6. The system of claim 1, wherein the altered password is encrypted, and the altered password is decrypted prior to changing the altered password to the cognitive password.

7. The system of claim 1, wherein the processor is further configured to alert a user associated with the first password when the second password is not identical to the first password.

8. A method comprising:
receiving a request to access a computer resource from an external device;
sending an identified pattern to the external device, wherein the identified pattern is one of a plurality of patterns that are computer instructions for altering contents of a cognitive password;
receiving from the external device an altered password, wherein the altered password is the cognitive password that has been altered in accordance with the identified pattern;
changing the altered password to the cognitive password by using an inverse of the identified pattern;
removing a dynamic sequence from the cognitive password to recover a second password, wherein the dynamic sequence comprises a dynamic sequence of characters that change on a periodic schedule;
comparing the second password to a first password, wherein the first password and the second password comprise a static sequence of characters; and
allowing the external device to access the computer resource when the second password is identical to the first password.

9. The method of claim 8, wherein the plurality of patterns comprises instructions to move a portion of a sequence of characters forming the cognitive password to a different location in the sequence of characters forming the cognitive password.

10. The method of claim 8, further comprises:
determining the sequence of characters and periodic schedule associated with the dynamic sequence from a selected type of dynamic sequence; and
receiving an indication of the selected type of dynamic sequence from the external device prior to receiving the altered password.

11. The method of claim 8, wherein the dynamic sequence of characters is based at least on a current date.

12. The method of claim 8, wherein the altered password is encrypted, and the altered password is decrypted prior to changing the altered password to the cognitive password.

13. The method of claim 8, further comprising alerting a user associated with the first password when the second password is not identical to the first password.

14. A non-transitory computer-readable medium storing instructions that, when executed by a processor, cause the processor to:
receive a request to access a computer resource from an external device;
send an identified pattern to the external device, wherein the identified pattern is one of a plurality of patterns that are computer instructions for altering contents of a cognitive password;
receive from the external device an altered password, wherein the altered password is the cognitive password that has been altered in accordance with the identified pattern;
change the altered password to the cognitive password by using an inverse of the identified pattern;
remove a dynamic sequence from the cognitive password to recover a second password, wherein the dynamic sequence comprises a dynamic sequence of characters that change on a periodic schedule;
compare the second password to a first password, wherein the first password and the second password comprise a static sequence of characters; and
allow the external device to access the computer resource when the second password is identical to the first password.

15. The non-transitory computer-readable medium of claim 14, wherein the plurality of patterns comprises instructions to move a portion of a sequence of characters forming the cognitive password to a different location in the sequence of characters forming the cognitive password.

16. The non-transitory computer-readable medium of claim 14, wherein instructions further cause the processor to:
determine the sequence of characters and periodic schedule associated with the dynamic sequence from a selected type of dynamic sequence; and
receive an indication of the selected type of dynamic sequence from the external device prior to receiving from the external device the altered password.

17. The non-transitory computer-readable medium of claim 14, wherein instructions further cause the processor to:
select a type of dynamic sequence from a plurality of types of dynamic sequences;
communicate the type of dynamic sequence to the external device prior to receiving from the external device the altered password; and
determine the sequence of characters and periodic schedule associated with the stored dynamic sequence from the selected type of dynamic sequence.

18. The non-transitory computer-readable medium of claim 14, wherein the dynamic sequence of characters is based at least on a current date.

19. The non-transitory computer-readable medium of claim 14, wherein the altered password is encrypted, and the altered password is decrypted prior to changing the altered password to the cognitive password.

20. The non-transitory computer-readable medium of claim 14, further comprising alerting a user associated with the first password when the second password is not identical to the first password.
